(19) United States
(12) Patent Application Publication
(10) Pub. No.: US 2005/0010374 A1
(43) Pub. Date: Jan. 13, 2005

(54) Method of analysis of NIR data

(75) Inventor: Zheng Jane Li, Quaker Hill, CT (US)

Correspondence Address: PFIZER INC., PATENT DEPARTMENT, MS8260-1611, EASTERN POINT ROAD, GROTON, CT, 06340, US

(73) Assignee: Pfizer Inc

(21) Appl. No.: 10/794,886

(22) Filed: Mar. 5, 2004

Related U.S. Application Data
(60) Provisional application No. 60/452,771, filed on Mar. 7, 2003.

(51) Int. Cl. G01N 31/00; G06F 19/00

(52) U.S. Cl. 702/28

(57) ABSTRACT

A method for providing qualitative analysis of solid forms of a chemical compound/or drug candidate including polymorphous, hydrates, solvates and amorphous solids that does not require an a prior knowledge of either the solid form or the total number of groups of solid forms.

This application claims priority to U.S. Provisional Application Ser. No. 60/452,771, filed Mar. 7, 2003.

### FIELD OF THE INVENTION

The present invention relates generally to the analysis of solid forms generally, and chemical compounds in the near infrared spectrum, and, more particularly, to a method of analysis of near infrared (NIR) diffuse reflectance data for the rapid identification of solid forms of chemical compounds useful in polymorph screen.

### BACKGROUND OF THE INVENTION

The use of near infrared spectroscopy for quantifying solid forms such as components of chemical compounds by measuring the absorption or transmission of light in the near-infrared range is well established. Measurements in the near infrared range are usually obtained either by transmitting light through the sample, near infrared transmission (NIRT), or by measuring the light reflecting from the surface of the sample, diffuse reflectance near infrared spectroscopy.

NIR is well known for its application in quantitative analysis. In fact, past analysis of spectroscopic data was almost without exception quantitative in nature, requiring knowledge of the total number of categories of the larger sample. It was believed necessary to use a set of standard spectra and apply quantitative equations for qualification of unknown samples. Some prior art NIR methods require a known standard for quantitation and qualification. The methods of the prior art require a library of spectra for known compounds for use as a basis for comparison to the unknown compounds. Diffuse reflectance near infrared spectroscope (NIRS) is widely known and well established in its application in quantitative analysis of solid samples.

Other prior art methods take similar approaches to identify unknown materials by comparing NIR spectra data of the unknown material with those of a plurality of known compounds to identify the unknown material or properties thereof.

Another drawback of the prior art is the substantial time needed to complete a comparison of an unknown material to a plurality of known materials, especially when the library of known materials is considerably large. In early polymorph screening, a large number of samples (100 to 200 samples) are generated and the rate-limiting step is the sample characterizations, which may take a few days to a week.

As noted, near infrared analysis has been used to identify unknown materials by comparing NIR curves of unknown materials to those of known compounds. One such method is disclosed in U.S. Pat. No. 4,766,551 to Begley issued Aug. 23, 1988. In the Begley method, a large number of known compounds are measured by determining the absorbance of each known product at certain wavelengths distributed throughout the NIR spectra curves therefor. The measurements at each of the predetermined wavelengths are considered to be an orthogonal component of a vector extending in one-dimensional space. The NIR spectra of an unknown material are also determined and measured at the same predetermined wavelengths to determine a similar vector extending in one-dimensional space. Next, the angles between the vector for the unknown material and the vectors for each of the known products are calculated. If the angle between the vectors for the unknown material and one of the known products is less than a predetermined minimum, the unknown material is considered to be the same as the known product.

The Gemperline et al. method disclosed in Analytical Chemistry, V. 67, pp. 160-167 (1995), uses a sample's normalized distance from a library of mean spectra. The wavelength distance characteristic of the Gemperline et al. method differs from other wavelength distance methods in that it employs parametric statistical tests and probability thresholds. Other prior art algorithms use parametric techniques which make “assumptions” about the population distribution. The Gemperline et al. wavelength distance method is parametric because it assumes that the spectroscopic measurements are taken from samples drawn at random from a normally distributed population. A decision threshold for hypothesis testing depends on both the number of training samples and the number of data points per spectrum. Diffuse reflectance near-infrared spectroscopy (NIRS) is employed to quantify samples in binary physical mixtures in which one form was the dominant component. A calibration plot can be constructed by plotting form weight percent against a ratio of second-derivative values of log (1/R¹) (where R′ is the relative reflectance) versus wavelength.

U.S. Pat. No. 5,822,219 to Chen et al. (hereinafter “'219”), incorporated herein by reference, teaches a method for identifying an unknown product using absorbance spectra of known products that are measured and stored in a library. A quick search using clustering techniques is conducted to narrow the search to a few products, followed by an exhaustive search of the spectra of the few products. More specifically, in the Chen et al. method, principal component analysis is applied to the absorbance spectra to generate product score vectors which are vectors extending in multidimensional hyperspace of condensed data that is representative of the known products.

The product score vectors are divided into clusters and subclusters in accordance with their relative proximity based on the position of the end point of each of the vectors. Hyperspheres, which are multidimensional spheres, are constructed around the vectors and an envelope is constructed to enclose each cluster surrounding the hyperspheres within the cluster. The absorbance spectrum of the unknown product to be identified is then measured and an unknown product score vector is determined from the unknown product spectrum corresponding to the product score vectors for the known products.

The '219 method includes a determination of whether or not the unknown product score vector falls within one of the envelopes of the product vectors for the known products. If so, it is then determined whether the product score vector for the unknown product is projected into the principal component inside model space of a cluster of the envelope. Next, it is determined whether or not the unknown product score vector falls within any of the sub-clusters divided from the cluster.

This process is repeated until the unknown product score vector is found to lie in a cluster that is not further subdivided. In this manner, the search is narrowed to a few products. An exhaustive search is then carried out to match the spectrum of the unknown product with the spectra of the known products corresponding to the undivided sub-cluster. At any point during a process if it is determined that the vector of the unknown product does not fall within any cluster or finally to correspond to any product in the final subcluster, the unknown product is considered to be what is known as an “outlier”, and is determined not to correspond to any of the known products.

In an article entitled, “Near-Infrared Spectrum Qualification via Mahalanobis Distance Determination”, by Richard G. Whitfield et al. and published in Applied Spectroscopy, 41:1204 (1987), a method is disclosed for qualifying a spectrum for quantitative analysis. The method, as detailed hereinafter, generates a distribution of spectra for compounds determined suitable for analysis. The spectrum of an unknown sample is generated and compared to the distribution using a method of qualitative analysis to determine whether the unknown sample qualifies for a quantitative analysis thereof. This method of qualitative examination is based on the Mahalanobis distance mathematical algorithm for chemical identification classification.

Other prior art methods take similar approaches to identify unknown materials by comparing NIRS data of the unknown material with those of a plurality of known compounds to identify the unknown material or properties thereof. It is clear, therefore, that none of the methods of the prior art allow for the qualitative analysis provided by the present invention, without a library of spectra for known compounds for use as a basis for comparison to the unknown compounds. The prior art also fails to teach a NIR technique that is adaptable for analysis of unsupervised pattern recognition to identify grouping of unknown samples in a high throughput screening process. The present invention overcomes these limitations.

### SUMMARY OF THE INVENTION

The present invention includes a novel application of NIRS to rapidly identify solid forms of a chemical compound by using a method for grouping the samples based on the solid forms of the compounds in a screen. Representative samples in the group of the same solid form can then be subjected to subsequent analysis for further characterization. The application of the present invention method eliminates redundant analysis of samples having the same solid form in the sample population, thereby improving the efficiency of a high throughput screening process of chemical compounds including drug candidates.

It is an object of the present invention is to provide a method of analysis useful for distinguishing solid forms of a chemical compound without prior knowledge of the total number of forms the compound may have in a large sample set.

It is another object of the present invention to provide a method of analysis that can be used to quickly classify samples into groups on the basis of solid forms and discriminate mixtures and non-group members.

Still another object of the present invention is to provide a method of analysis useful in screening large numbers of samples having a plurality of solid forms by eliminating redundant analysis of the same forms.

According to one aspect of the present invention, a method of analysis of NIR data for identifying various solid forms, including those of a chemical compound includes the steps of obtaining a NIR spectrum for each of a plurality of samples of a chemical entity over a range of wavelengths. Thereafter, derivative spectra for the NIR spectra are determined. The method further includes the steps of performing cluster analysis of the NIR derivative spectra to identify group members of a given sample set and evaluating the groups and group members and outliers.

Accordingly, the present invention also provides a method of analysis of NIR data for identifying various solid forms including those of a chemical compound or drug candidate, the method including the steps of: obtaining an NIR spectrum for each of a plurality of samples of a chemical compound over a range of wavelengths in the NIR spectrum (1100 to 2500 nm being typical); computing second derivative spectra for the NIR spectra; applying principal component analysis (PCA) of the second derivative spectra at predetermined wavelengths either the entire wavelength region or a selected wavelength region for segregating the samples; identify the groups and group membership from the PCA graph and further evaluating group members by calculating Mahalanobis distances of a given group to assess the qualification of the group members. For each cluster a Mahalanobis distance can be determined wherein an acceptance level can be used to exclude from the group's outliers or otherwise nonconforming or contaminated samples.

The present invention includes application of cluster analysis of NIR spectra using principal component analysis (PCA) techniques for segregating the samples into groups. A Mahalanobis distance algorithm is then utilized to calculate the Mahalanobis distance between the clustered data and established discrete groups of the samples having the same solid form. The non-cluster samples or outliers are either impure in terms of chemical or physical form or a single-member solid form. Accordingly, utilization of the method of the present invention quickly provides a determination of the number of groups of solid forms in a polymorph screening process thereby increasing the efficiency of an overall screening process by eliminating redundant screening of the same solid forms.

### BRIEF DESCRIPTION OF THE DRAWINGS

FIG. 1 is a simplified schematic illustration of an apparatus used to practice the present invention.

FIG. 2 is a simplified diagrammatic illustration of a prior art method of near infrared reflectance analysis (NIRA), which attempts to address the lack of qualitative feedback characteristic of near infrared spectroscopy.

FIG. 3 is an algorithm provided according the present invention that generates qualitative data on the number of solid forms in an overall sample of solid forms.

FIG. 4 is a graphical illustration of representative NIR spectra of four solid forms of a drug compound obtained in practicing a method of the present invention.

FIG. 5 is a simplified graphical illustration of second derivative NIR spectra obtained from the NIR spectra of FIG. 4.

FIG. 6 is a simplified diagrammatic illustration of principal component plot of clusters of a sample set whose representative NIR spectra are seen in FIG. 4.

FIG. 7 is a graphical illustration of second derivative NIR spectra of a compound obtained with alternative software.

FIG. 8 is a three (3) dimensional cluster plot of the second derivative NIR spectra of FIG. 7.

FIG. 9 is a simplified graphic illustration of second derivative spectra of 45 samples in a sample set obtained using an alternative software useful with the present invention.

FIG. 10 is a two-dimensional principle component analysis (PCA) score plot with sample labels for the NIR spectra of FIG. 7.

FIG. 11 is a simplified graphical illustration of a PCA score plot of PC1 versus PC3 for the NIR spectra of FIG. 7.

FIG. 12 is a simplified graphical illustration of a PCA score plot of PC2 versus PC3 for the NIR spectra of FIG. 7.

### DETAILED DESCRIPTION OF THE INVENTION

The present invention is drawn to a near infrared (NIR) technique capable of distinguishing solid forms of a chemical compound/drug candidate including polymorphs, hydrates, solvates, amorphous solids and mixtures thereof. To apply NIR for rapid sample screen, the present invention employs cluster analysis to separate the samples into groups of same solid form and to discriminate mixture. The present invention also provides for the analysis of large quantity of samples of different solid forms in a high throughput screen. One target application is in the automation of hydrate/polymorph screening. The present invention eliminates redundant analyses of the same solid form, thereby reducing total sample analysis and improving the efficiency of a high throughput process.

NIRS is able to distinguish solid forms of a chemical compound/drug candidate including polymorphs, hydrates, solvates, amorphous solids and mixtures thereof. Combination of rapid sample analysis and discriminant capability, NIRS has a great potential as an analytical tool for the high throughput screen process. The speed of NIRS analysis comes in both the rapid data collection and the fast data analysis with clustering techniques and high-speed computers.

NIRS enables the user to obtain analysis without directly handling the analytes by transmitting lights in NIR region through the clear glass of a typical sample vial as neat solids. For data collection, NIRS allows the sampling of solids with relative speed (1-2 min/sample) and safety when compared to other common crystal form characterization methods, such as powder X-Ray diffraction (PXRD) differential scanning calorimetry (DSC), or mid-infrared spectroscopy, which requires on average 20 minutes/sample for data preparation and collection.

The data analysis of NIRS involves applying the powerful algorithms that allows distinguishing what are often small absorbance differences within a short time. The use of diffuse reflectance NIRS to rapidly identify possible solid forms of drug candidates is on basis of pattern recognition. The fundamental idea is that a unique solid form will have a unique NIR spectrum/pattem distinguishable from other solid forms and the differences among the solid forms, although small, can be readily recognized by multivariate data analysis such as cluster techniques. To apply NIR for rapid sample screen, cluster analysis is employed to categorize the samples into groups of same solid form and to differentiate mixtures as non-group members or outliers.

With the present invention, one can analyze large quantity of samples of different solid forms in much shorter time than other techniques, which is particularly useful in a high throughput screen such as a polymorph screen. One target of this invention is the automation of the hydrate/polymorph screen that generates a large number of samples and the sample analysis is rather time-consuming. The use of NIRS is to first identify the clusters/forms and then select the representative samples in each cluster/form for further analysis with other techniques. This will eliminate the redundant analyses of the same solid form to significantly reduce the total sample analysis time and to improve the efficiency of a high throughput process.

The present invention then provides a NIRS method of grouping large quantities of polymorph screen samples on the basis of their crystal/solid form by testing several drug candidates. A benefit of this invention lies in its utility in the rapid analysis of the automated polymorph screen and bulk samples.

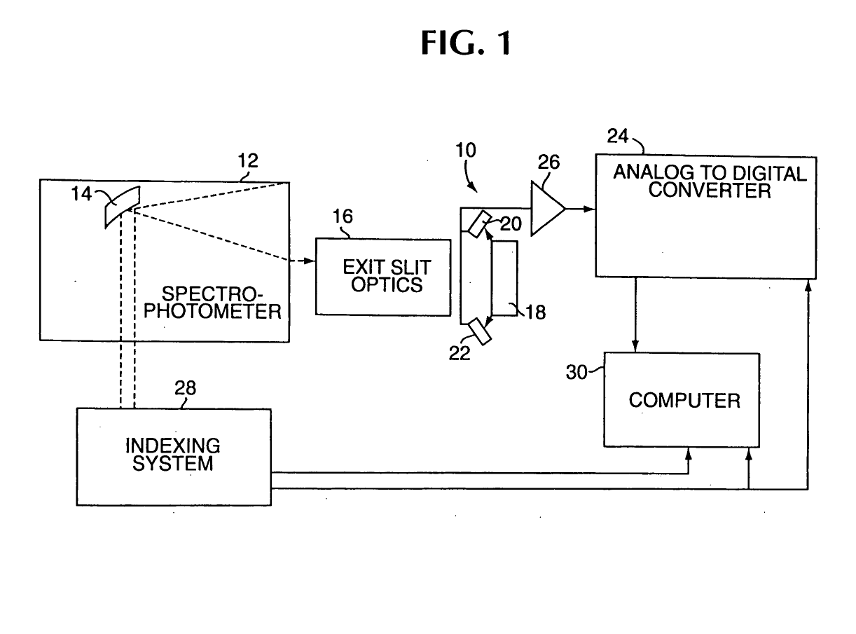

Referring now to FIG. 1, there is shown in simplified schematic form an apparatus 10 which can be employed in practicing a method of the present invention. The apparatus includes a near infrared spectrometer 12 having an oscillating grating 14 on which the spectrometer directs light. The grating 14 reflects light with a narrow wavelength band through exit slit optics 16 to a sample 18. As the grating oscillates, the center wavelength of the light that irradiates the sample is swept through the near infrared spectrum.

Light from the diffraction grating that is reflected by the sample is detected by infrared photodetectors 20, 22. The photodetectors generate a signal that is transmitted to an analog-to-digital converter 24 by amplifier 26. An indexing system 28 generates pulses as the grating 14 oscillates and applies these pulses to a computer 30 and to the analog-to-digital converter. In response to the pulses from the indexing system, the analog-to-digital converter converts successive samples of the output signal of the amplifier 26 to digital values. Each digital value thus corresponds to the reflectivity of the sample at a specific wavelength in the near infrared range.

The computer 28 monitors the angular position of the diffraction grating and accordingly monitors the wavelength irradiating the sample as the grating oscillates, by counting the pulses produced by the indexing system 26. The pulses produced by the indexing system 26 define incremental index points at which values of the output signal of the amplifier are converted to digital values. The index points are distributed incrementally throughout the near infrared spectrum and each corresponds to a different wavelength at which the sample is irradiated. The computer 28 converts each reflectivity value to an absorbance of the material at the corresponding wavelength. The apparatus of FIG. 1 is used to measure and obtain an absorbance spectrum of each sample of each product thus providing a plurality of spectra for each product. Each spectrum is measured at the same incremental wavelengths.

The structure and operation of a suitable spectrometer is described in greater detail in U.S. Pat. No. 4,969,739, incorporated herein by reference. Other available apparatus, which may be adapted and used with the present invention, are marketed by Foss NIR Systems of Silver Spring, Md. and the Symyx Company.

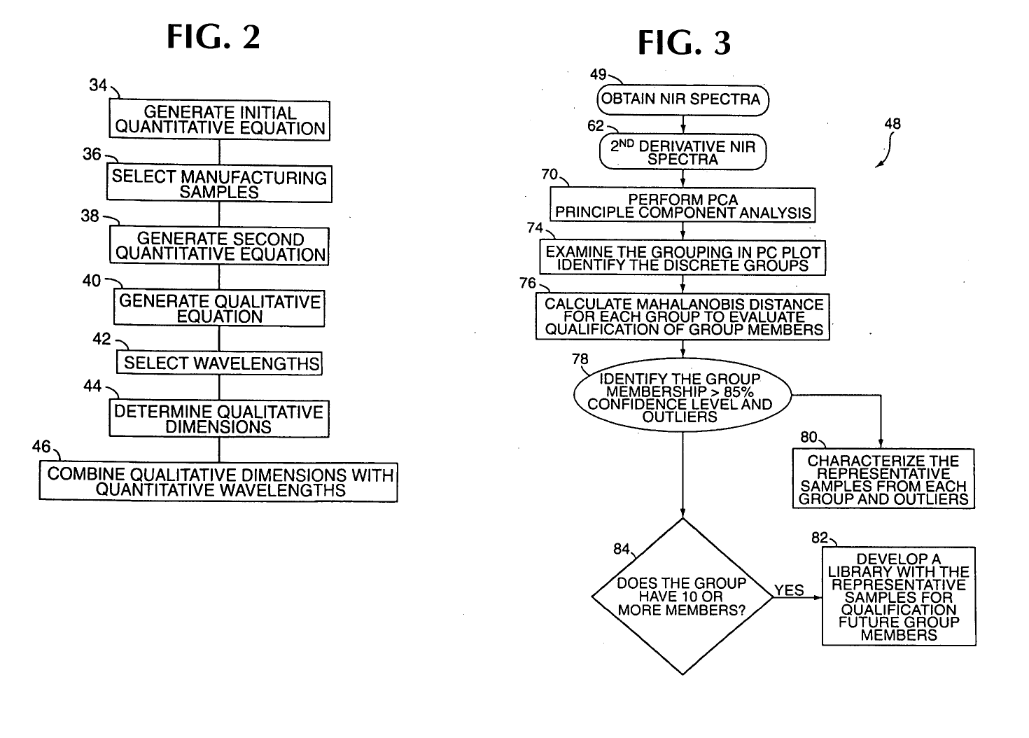

FIG. 2 is a simplified schematic illustration of an algorithm 32 set forth in the above-mentioned Whitfield article. The algorithm in FIG. 2 is used with a near-infrared reflectance analysis (NIRA) to address the lack of qualitative feedback with this technique.

A NIRA quantitative equation typically includes a calibration set that is composed of samples, which are representative of the range of concentration necessary to enable correlation. If samples are to narrow range to permit adequate correlation, an additional process must be used to permit adequate correlation. At step 34 of FIG. 2, an initial quantitative equation is developed using laboratory standards. At block 36, manufacturing samples are selected for inclusion in a second calibration set with the selection based upon the residuals, that being the difference between the NIRA and the referenced method determinations. These were obtained with the use of the equation generated at step. The laboratory standards are also included in the calibration set. This second calibration set is used to generate a second quantitative equation at block 38.

The generation of the quantitative equation is followed by the development of a qualitative equation. First, spectra of the calibration set are classified according to the sign and magnitude the residuals obtain with the use of the equation developed above at step 40. The criteria used for classifying the spectra are arbitrary and depend upon the requirement of the application.

At block 42, the wavelengths, which minimize the sum ij (1/D ij), are determined. These become the operative qualitative dimensions. The qualitative dimensions are, at block 44, combined with the quantitative wavelengths identified above at step to characterize the multi-dimensional space of interest. With the use of these dimensions and spectra that are found to have acceptably small residuals, the distribution is established for qualifying unknown spectra for quantitation, block 46.

One of the drawbacks of the Whitfield method is the prerequisite of a known sample universe. In Whitfield, this takes the form of an approved distribution of spectra that has been pre-established as “suitable for analysis”, thereby selecting a sample set which is representative of the range of samples and allow for correlation, see Whitfield et al, at p.1206. Consequently, the Whitfield method is not a true qualitative method, as is the present invention, but is seen to add a qualitative step to a quantitative process. The present invention as seen from the preferred embodiments set forth hereinafter does not require pre-establishment of “known” spectra for successful operation.

FIG. 3 shows a typical NIR spectrum for a chemical compound wherein the relative absorbance is plotted as a function of wavelength over the near infrared range. The spectrum shows the method of the present invention includes the use of NIR. Representative spectra of individual samples can be collected on a Foss NIR Systems equipped with an autosampler. This instrument includes a rotating carousel from which samples are placed and a Rapid Content Analyzer (RCA), which collects each spectrum singly through the bottom of its clear glass vial. Diffuse reflectance spectra can be collected at 2 nm resolutions relative to an internal ceramic reference standard in the wavelength range of 1100 to 2500 nm.

In early polymorph screen, a large number of samples (100 to 500 samples) are generated and the sample characterization is the rate-limiting step, which may take a few days to a week. For rapid identification solid forms of a drug candidate, a qualitative NIR method has been established with the present invention. It has been found that the cluster analysis of NIR spectra is highly reliable to discover the groups as solid forms of a drug candidate. A discrete group is composed of the samples of the same solid form, whereas the scattered samples (non-cluster samples) are impure in terms of either chemical or physical (mixtures of forms) or a unique physical form. This procedure will provide a rapid read-out for the number of groups (solid forms) from polymorph screen and reduce the total number of subsequent sample analysis by selecting representative samples in each cluster.

Cluster analysis is performed in the embodiment of FIG. 3 using Principle Component Analysis (PCA) via Mahalanobis distance for solid form identification. Those skilled in the art will note that other analysis techniques can be used when appropriate for that application. The mathematical algorithm of Mahalanobis distance calculation is employed to identify the closeness of a group members and outliers. Unlike conventional NIR methods relying on known standard, the present method can identify and display the groups of the solid forms without imposing class membership on the samples. In other words, this unsupervised pattern recognition of NIR spectra is effective in grouping of samples and outliers in different solid forms of a drug candidate.

The method of FIG. 3 uses the following five steps in a preferred embodiment:
1. Collect NIR spectra of polymorph screen samples;
2. Obtain 2nd derivative spectra;
3. Apply PCA (explain>85% variance) to examine the groups/clusters;
4. Calculate Mahalanobis distance with confidence level 0.85 to 0.95 to evaluate the group members and outliers; and
5. Develop a library with the representative samples to predict future group member of unknown samples.

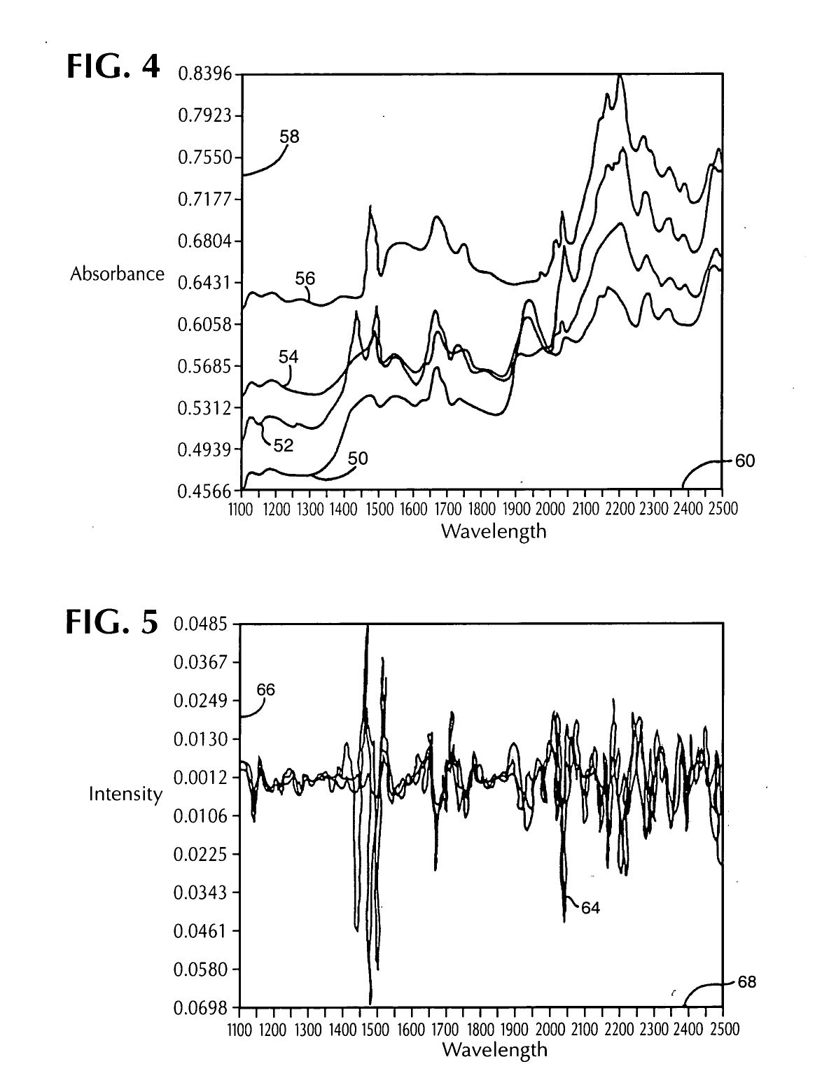

Referring now to FIG. 3, there as shown in simplified schematic form an algorithm 48 provided according to the present invention. First, NIR spectra are generated (block 49) from polymorph screen samples, which typically range from 50 to 200 in number. An example of NIR spectra of four solid forms is seen graphically illustrated in FIG. 4. Representative NIR spectrum of each product form corresponds to curves 50-56, inclusive. Axes 58, 60 respectively correspond to absorbance and wavelength. Although the method of FIG. 3 utilizes the entire IR spectrum, alternative embodiments may use a subset of wavelengths selected in accordance with the application.

Thereafter, the 2nd derivative NIR spectra are generated at block 62, FIG. 3. FIG. 5 graphically illustrates the second derivative spectra 64 for the spectra of FIG. 4, where the small differences become more evident. Note that, depending on the application, first derivative spectra may suffice. Alternatively, higher order derivative spectra may be required to make the small differences more evident. Axes 66, 68 respectively correspond to intensity and wavelength. Principal component analysis (PCA) of second derivative spectra with confidence level in excess of 85% is performed to examine the groups/clusters (block 70). The samples are divided into groups and the discrete groups are identified at block 74.

The Mahalanobis distance is calculated at block 76, with a confidence level of 0.85 to 0.95 selected to further discriminate the group members (block 78) and select the representative samples from each group (block 80). Mahalanobis distance is one calculation that can be used to evaluate groups and group members. Those skilled in the art will note that other evaluation techniques can be used as appropriate. Thereafter, a library is developed (block 82) with representative samples to predict future group members of unknown samples should the group have more than 10 members, or fewer should the members represent 50% or more of the sample set (block 84). The total number of groups is then determined.

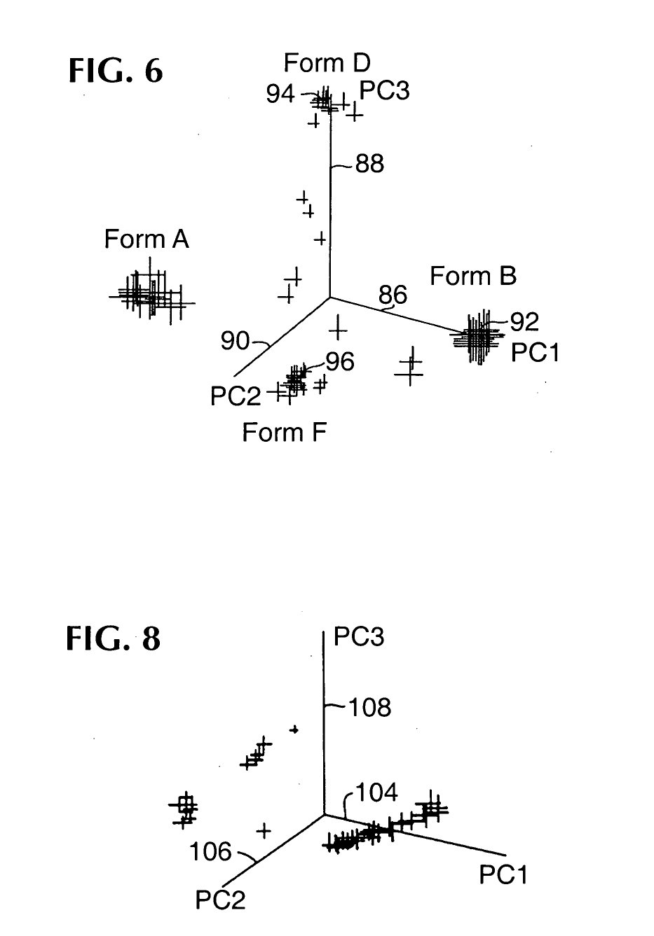

FIG. 6 represents a graphical illustration (PCA plot) of the cluster analysis performed for the compound of FIG. 4. In FIG. 6, axes 86, 88 and 90 respectively correspond to the principle components PC1, PC3, and PC2, respectively. Clusters 92, 94 and 96 correspond to Forms B, D, and F.

In practice, the present invention has been used to evaluate 7 (seven) pharmaceutical compounds with a total of 224 samples and 20 solid forms. The solid form identification has been verified by powder X-ray diffraction (PXRD), as well as differential scanning calorimetry (DSC) analysis. These tests confirm that the correct identification of solid forms by methods of the present invention was 99%. These results demonstrate the effectiveness of the present invention in the identification of solid forms for polymorph screen samples.

Set forth below is a summary table of the results for several compounds using the method of the present invention. Samples of seven drug compounds were used. Although the numbers of solid forms are known for these samples, the samples were treated as unknown initially in NIRS analysis. The clustering data obtained from NIRS cluster analysis was used to compare with the form ID by PXRD to verify the accuracy of the NIRS analysis and to test the reliability of the present method.

SUMMARY TABLE OF EXAMPLES OF NIRS IDENTIFICATION

| | Number of | Number of | Correct | Incorrect | |
|---|---|---|---|---|---|
| Compound | NIR clusters | samples | ID | ID | % Correct |
| 1 | 4 | 77 | 76 | 1 | 98.7 |
| 2 | 2 | 27 | 27 | 0 | 100 |
| 3 | 3 | 17 | 17 | 0 | 100 |
| 4 | 2 | 16 | 16 | 0 | 100 |
| 5 | 2 | 18 | 17 | 1 | 94.4 |
| 6 | 3 | 47 | 47 | 0 | 100 |
| 7 | 4 | 22 | 22 | 0 | 100 |
| Total | 20 | 224 | 222 | 2 | 99.1 |

As noted above, for this particular test there were a total of 224 samples of which there were 20 NIR clusters and 7 compounds. All test compounds were pharmaceutical active agents, including a variety of organic structures. Some of these compounds are proprietary to the Assignee of the present invention. The total known crystal forms of each compound may be greater than the number of NIR clusters, if a unique solid form has only one member. However, in all cases, the more stable forms are present, shown as clusters with large membership or high populations.

To verify the accuracy of sample identification, the results from NIRS cluster analysis have been compared to powder X-ray diffraction (PXRD) patterns of the samples. The correct identification corresponds to that identification by the present invention, which agrees with X-ray diffraction and/or DSC (differential scanning calorimetry) data as a substantially pure form. In contrast, incorrect identification means that the identification by present invention disagrees with the X-ray diffraction and/or DSC data. Errors were reported on the foregoing table where the results of the analytical techniques did not agree.

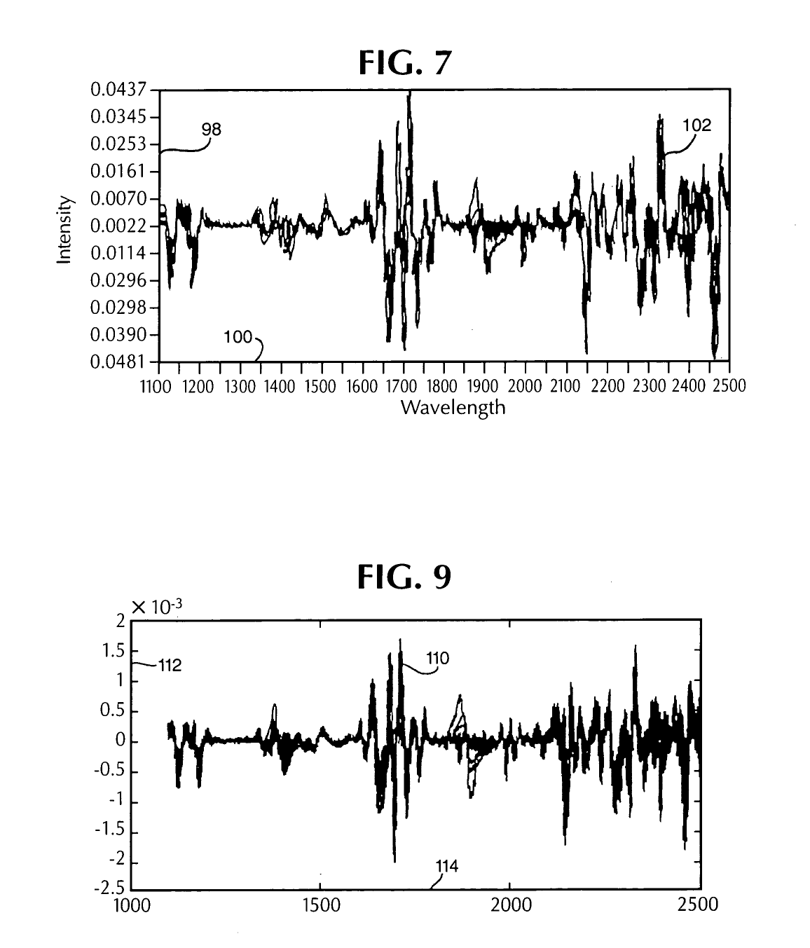

FIGS. 7 and 8 graphically illustrate data obtained from Compound 6 listed in the above table in another test. In FIG. 7, axes 98, 100 correspond to absorption spectra intensity and wavelength, respectively, with curves 102 collectively illustrating the second derivative NIR spectrum of each form. FIG. 8 is a simplified schematic illustration of 3D cluster plots similar to that shown in FIG. 6, and graphically illustrates the distribution of samples 103 for several forms. As in FIG. 6, axes 104, 106, 108 correspond to PC1, PC2, and PC3, respectively.

Another exemplary implementation of the algorithms of the present invention is seen with respect with FIGS. 9 through 12. In this analysis, the “MatLab” software, a commercially available analysis tool was used for data analysis with the present invention. This system provides a more detailed and independent cluster analysis procedure. First, second derivative spectra were obtained from each of the 45 spectra graphically illustrated at 110 in FIG. 9, where axes 112, 114 correspond to second derivative value and wavelength, respectively. This was taken for 45 samples using 11 point, 3^{rd} order polynomial Savisky-Golay second derivative.

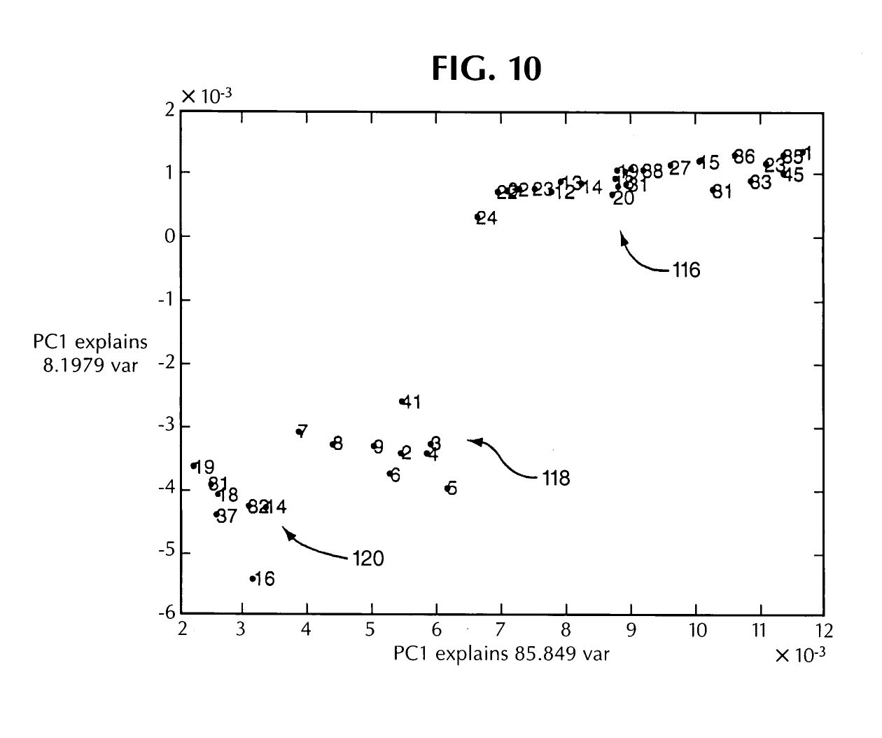

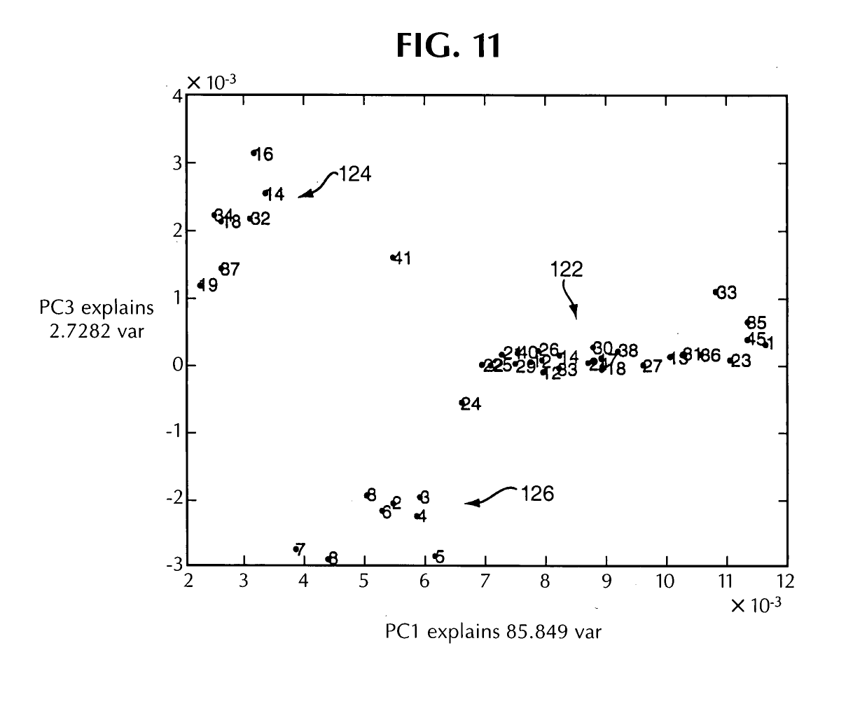

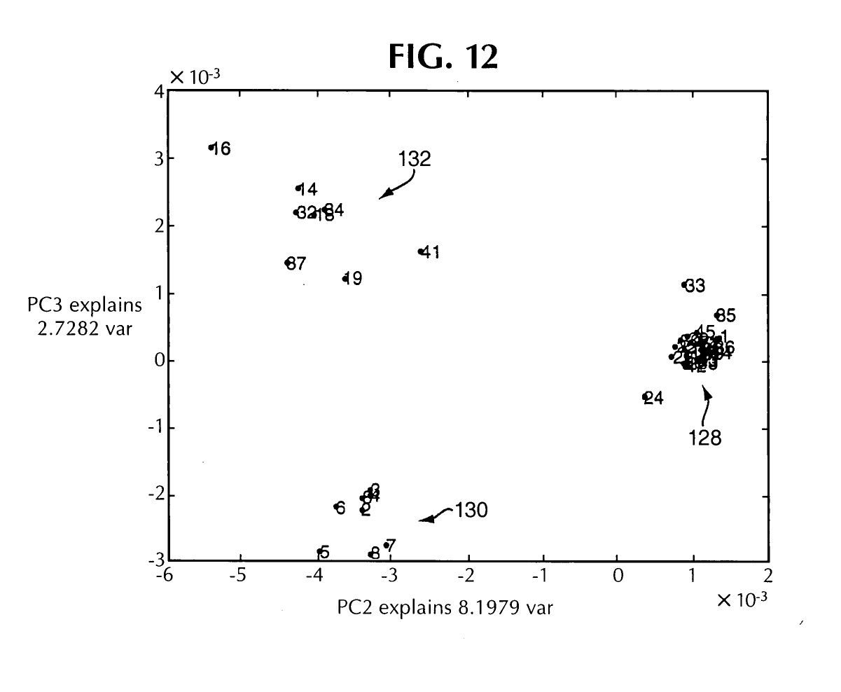

The principle component analysis was performed on the full wavelength range, second derivative spectra. The two dimensional PCA score plot is a tool to explore the data and the variances for each principal component. The PCA score plots of PC1 vs. PC2, PC1 vs. PC3, and PC2 vs. PC3, were generated, and one is shown diagrammatically in FIGS. 10-12. FIG. 10 contains an illustration of PCA score plot having clusters 116-120 of PC1 vs. PC2. PCA score plot of PC1 vs. PC3 is shown in FIG. 11, with data 122, 124 and 126 corresponding to different clusters, as does data 128, 130 and 132 in FIG. 12. For each of the three clusters, the Mahalanobis distance of each sample to the cluster center was calculated in a threshold value as established at the 0.05 probability level (95% confidence level). The formula for the threshold calculation is derived from equation one (1) of the Gemperline method referenced above and set forth below:
Dᵢ²=(X−Xᵢ)Mᵢ(X−Xᵢ)′
where
X is a multidimensional vector describing the location of sample x,
Xᵢ is a multidimensional vector describing the location of the group mean of species i,
(X−Xᵢ)′ is a transpose vector of (X−Xᵢ),
M_{f} is the inverse sample variance-covariance matrix derived from the training distribution of species i (this matrix defines the distance measures on the multidimensional space), and
Dᵢ is the square root of Dᵢ², which is the Mahalanobis distance of an observation (spectrum) to the centroid of the training distribution for species i.

In the past, cluster analysis of NIR spectroscopic data was quantitative in nature only, requiring known standards. In contrast, the present invention is used where the standard of each solid form is not known, a priori. In a preferred embodiment, the method and apparatus can be used to sort solid forms of a chemical compound/drug candidate into groups of the same solid form and thereby discriminate among the samples.

It has been demonstrated by the present invention that cluster analysis of NIRS spectra is highly reliable to discover the groups as solid forms of a drug candidate. A discrete group is composed of the samples of the same solid form, whereas the scattered samples (non-cluster samples) are impure in terms of either chemical or physical (mixtures of forms) or a unique physical form. The present invention will provide a rapid read-out for the number of groups (solid forms) from polymorph screen and reduce the total number of subsequent sample analysis by selecting representative samples in each cluster.

While the present invention has been described with reference to the preferred embodiment, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

1. A method of analysis of NIR data for identifying various solid forms, including those of a chemical compound, the method comprising of the steps of:
obtaining a NIR spectra for each of a plurality of members of a sample of the solid form over a range of wavelengths;
determining derivative spectra for said NIR spectra;
performing cluster analysis of said NIR derivative spectra to identify group members of a given sample set; and
evaluating said groups and group members and outliers.

2. The method of claim 1 further comprising the step of computing the total number of said groups.

3. The method of claim 1 further comprising the step of selecting a portion of said wavelength region.

4. The method of claim 1 further comprising the step of generating a higher order derivative spectra.

5. The method of claim 1 further comprising the step of computing the total number of said groups.

6. The method of claim 6 wherein said cluster analysis step further comprises the step of applying principal component analysis of said second derivative spectra at predetermined wavelengths for segregating said second derivative spectra into clusters.

7. The method of claim 1 wherein said cluster analysis step further comprises the step of calculating a relative Mahalanobis distance between said second derivative spectra at said predetermined wavelengths.

8. The method of claim 1 further comprising the step of generating a library of said groups.

9. The method of claim 1 wherein said step of identifying group members includes a step of determining a range of acceptable Mahalanobis distances for said groups.

10. The method of claim 1 further comprising of the steps of:
obtaining second derivative spectra from said derivative spectra;
performing principle component analysis;
examining data from said principle component analysis;
evaluating said groups and group members using Mahalanobis distance; and
generating a library for identification of further group members.

11. The method of claim 10 wherein said cluster analysis step further comprises selection of entire wavelength (1100-2500 nm).

12. A method of identification of solid forms comprising the steps of:
selecting samples for identification from a group of samples, said group having an unknown number of solid forms;
generating NIR spectra of a plurality of solid forms;
obtaining derivative spectra from said NIR spectra for each of said selected samples;
performing a cluster analysis for each of said selected samples;
dividing said selected samples into groups;
identifying discrete ones of said groups;
calculating a Mahalanobis distance value for each of said discrete groups; and
determining a total number of said discrete groups.

13. The method of claim 12 further comprising the step of selecting a confidence value for said Mahalanobis distance corresponding to membership in a one of said discrete groups.

14. The method of claim 13 further comprising the step of generating a library of discrete groups from said selected ones of said solid forms.

15. The method of claim 14 further comprising the steps of selecting a value corresponding to the number of identified members in a one of said groups so as to be included in said discrete group library.

16. The method of claim 12 wherein said cluster analysis step further comprises the steps of principal component analysis.

17. The method of claim 13 further comprising the step of selecting said confidence value to be approximately 0.85.
